(19) United States
(12) Patent Application Publication
(10) Pub. No.: US 2019/0236128 A1
(43) Pub. Date: Aug. 1, 2019

(54) SYSTEM AND METHOD FOR GENERATING A NOTIFICATION RELATED TO AN ELECTRONIC DOCUMENT

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 16/379,156

(22) Filed: Apr. 9, 2019

Related U.S. Application Data
(63) Continuation of application No. PCT/US2018/013490, filed on Jan. 12, 2018.
(60) Provisional application No. 62/445,250, filed on Jan. 12, 2017.

(51) Int. Cl. G06F 17/24; G06F 16/93; G06F 16/245

(52) U.S. Cl. CPC G06F 17/248; G06F 16/245; G06F 16/93

(57) ABSTRACT

A system and method for generating a notification related to an electronic document including at least partially unstructured data. The method includes analyzing the electronic document to determine at least one transaction parameter, the at least one transaction parameter indicating at least one entity; creating a template for the electronic document, where the template is a structured dataset including the at least one transaction parameter; determining, based on the template, an entity device associated with one of the at least one entity; and sending, to the entity device, a notification requesting additional information for the electronic document.

### CROSS-REFERENCE TO RELATED APPLICATIONS

This application is a continuation of International Application PCT/US2018/013490 filed Jan. 12, 2018, which claims the benefit of U.S. Provisional Application No. 62/445,250 filed on Jan. 12, 2017.

The contents of the above-referenced applications are hereby incorporated by reference.

### TECHNICAL FIELD

The present disclosure relates generally to evidencing electronic documents, and more particularly to identifying missing valid evidencing electronic documents and generating a notification requesting such documents.

### BACKGROUND

Enterprises all over the world often spend large amounts of money on goods and services purchased by the enterprises' employees in the course of regular business. Portions of these transactions may be refundable such that, for example, the enterprise can reclaim a value added tax (VAT) or deduct qualified expenses from a corporate income tax (CIT). Such expenses may be reported to the relevant tax authorities in order to reclaim at least a partial tax refund for the expenses made.

The VAT is a consumption tax paid on purchases of products in certain countries that is based on the increases in value of the purchased product at each stage of its production or distribution. VAT taxes paid on some types of goods may be refunded depending on the jurisdiction in which the purchase is made. The CIT is a tax on the profits of corporations in the United States of America that is equal to a corporation's receipts less allowable deductions such as costs of goods sold, wages paid and other employee compensations, paid interest, certain taxes, depreciation, and advertising costs.

In many cases, to obtain a refund or deduction, the enterprise is required to provide evidencing documents to the tax authority such as receipts, invoices, and the like, associated with the expenses made. These evidencing documents may need to be submitted along with a statement of the relevant parameters for the transaction such as a date, time, types of goods purchased, and the like. A report including the evidences and any necessary statements is prepared and provided to appropriate tax authorities to obtain the refund.

Many larger enterprises employ hundreds or thousands of employees, where many of them submit documents related to work expenses and purchases, including evidencing electronic documents. Tracking large numbers of such documents can quickly become unwieldy and time consuming. Further, invalid or incomplete evidencing documents may be submitted my employees for various reasons and must be identified and corrected, wherein invalid evidencing documents may be, for example, a document missing a parameter that is required for submission to a tax authority.

One method of correcting invalid or incomplete evidencing documents is to manually analyze all documents submitted to an enterprise, identify invalid or incomplete documents, determine an employee or individual responsible for each invalid or incomplete document, and communicate with the identified individual in order to request an updated or corrected version of the document. As this process can often include reviewing many documents and initiating communication with many employees, it can become tedious and inefficient, in addition to being difficult to execute without errors.

Some solutions exist for automatically managing evidencing documents to ensure compliance with jurisdictional rules. However, these solutions do not offer a method of automatically determining a responsible party associated with an invalid document and sending the party a request notification to obtain any relevant missing information. Further, these solutions face challenges in efficiently and accurately processing the evidencing documents when the evidencing documents are submitted in unstructured formats, for example when the evidencing document is in the form of a scanned receipt or invoice.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a notification related to an electronic document including at least partially unstructured data. The method includes analyzing the electronic document to determine at least one transaction parameter, the at least one transaction parameter indicating at least one entity; creating a template for the electronic document, where the template is a structured dataset including the at least one transaction parameter; determining, based on the template, an entity device associated with one of the at least one entity; and sending, to the entity device, a notification requesting additional information for the electronic document.

Certain embodiments disclosed herein also include a non-transitory computer readable medium having stored thereon causing a processing circuitry to execute a process, the process including: analyzing the electronic document to determine at least one transaction parameter, the at least one transaction parameter indicating at least one entity; creating a template for the electronic document, where the template is a structured dataset including the at least one transaction parameter; determining, based on the template, an entity device associated with one of the at least one entity; and sending, to the entity device, a notification requesting additional information for the electronic document.

Certain embodiments disclosed herein also include a system for generating a notification related to an electronic document including at least partially unstructured data. The system includes: a processing circuitry; and a memory, the memory containing instructions that, when executed by the processing circuitry, configure the system to: analyze the electronic document to determine at least one transaction parameter, the at least one transaction parameter indicating at least one entity; create a template for the electronic document, wherein the template is a structured dataset including the at least one transaction parameter; determine, based on the template, an entity device associated with one of the at least one entity; and send, to the entity device, a notification requesting additional information for the electronic document.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a notification generator according to an embodiment.

FIG. 3 is a flowchart illustrating a method for generating a notification related to an invalid evidencing electronic document according to an embodiment.

FIG. 4 is a flowchart illustrating a method for creating a structured dataset template based on an electronic document according to an embodiment.

FIG. 5 is a flowchart describing a method for generating a notification interface according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating a notification related to an invalid evidencing electronic document. An invalid evidencing electronic document is analyzed to determine an entity associated with the document, such as an employee or other individual responsible for submitting the electronic document. An entity device related to the determined entity is identified, for example over a connected network. A notification is generated related to the invalid evidencing electronic document and sent to the identified entity device. The notification may include a request for information, including a submission of a new version of the evidencing electronic document or a submission of a transaction parameter related to the evidencing electronic document.

In an embodiment, the evidencing electronic document, or evidence, is an at least partially unstructured document. A template is created based on the at least partially unstructured electronic document. The template is a structured dataset including transaction parameters, and is created based on key fields and values identified in the evidencing electronic document. The structured dataset template allows for more efficient and accurate processing of transaction parameter data as compared to transaction parameter data that is not in a structured format. Specifically, relevant portions of the template may be identified and used based on the structure of the template more quickly and more accurately than analyzing all data in an unstructured electronic document.

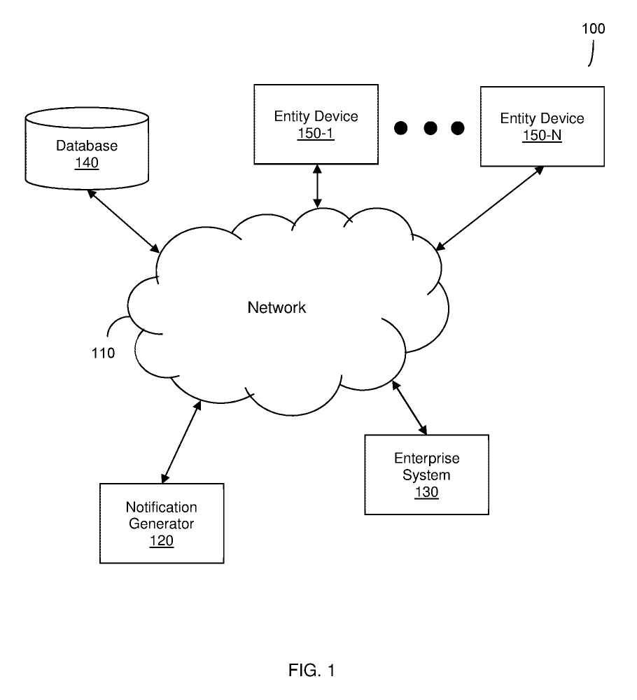

FIG. 1 shows an example network diagram 100 utilized to describe the various disclosed embodiments. In the example network diagram 100, a notification generator 120, an enterprise system 130, a database 140, and a plurality of entity devices 150-1 through 150-N (hereinafter referred to individually as an entity device 150 and collectively entity devices 150, merely for simplicity purposes), are communicatively connected via a network 110. The network 110 may be, but is not limited to, a wireless, cellular, or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or by representatives or employees of the enterprise as well as data related to the enterprise itself. The enterprise system 130 may further store data related to requests (e.g., requests for VAT reclaims or CIT reclaims) to be submitted by the enterprise (e.g., an image file showing a VAT reclaim request form completed by an employee of the enterprise to be submitted to a taxing authority). The enterprise may be, but is not limited to, a business whose employees purchase goods and services subject to VAT taxes while abroad, or whose purchases may be eligible for CIT deductions. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file; a text file; a spreadsheet file; a portable document format (PDF) file; etc.). The contents of the electronic documents may include, e.g., an invoice, a tax receipt, a purchase number record, a VAT reclaim request, a tax report indicating a CIT deduction, and the like. Data included in each electronic document may be at least partially unstructured, i.e., structured, semi-structured, unstructured, or a combination thereof. The structured or semi-structured data may be in a format that is not recognized by the notification generator 120 and, therefore, may be treated as unstructured data.

The database 140 may store data utilized by the notification generator 120 to generate a notification related to invalid evidencing electronic documents. Such data may include, but is not limited to, templates created based on evidencing electronic documents, incomplete or invalid evidencing electronic documents, evidencing requirements, and the like. An invalid evidencing electronic document may include a document missing one or more evidencing requirements for submission. The evidencing requirements may be further associated with one or more jurisdictions (e.g., one or more countries), uses of evidence (e.g., VAT reclaims, CIT deductions, etc.), a combination thereof, and the like. The evidencing requirements may be retrieved from one or more data sources (not shown), for example, data sources of tax authorities that include rules for requirements of evidencing electronic documents.

The entity devices 150 are operated by or associated with entities who are associated with the enterprise and may have submitted evidencing electronic documents, or evidences, such as receipts and invoices. As a non-limiting example, the entity device 150 may be, but is not limited to, a personal computer, a laptop, a tablet computer, a smartphone, a wearable computing device, and the like, belonging to an employee of the enterprise. In some implementations, the entity device 150 may be directly connected to the enterprise system 130 (not shown).

In an embodiment, the notification generator 120 is configured to create a template based on transaction parameters identified using machine vision of a received invalid evidencing electronic document. The evidencing electronic document is an at least partially unstructured electronic document that serves as evidence of a transaction. In a further embodiment, the notification generator 120 may be configured to retrieve the invalid evidencing electronic document from, e.g., the enterprise system 130 or the database 140.

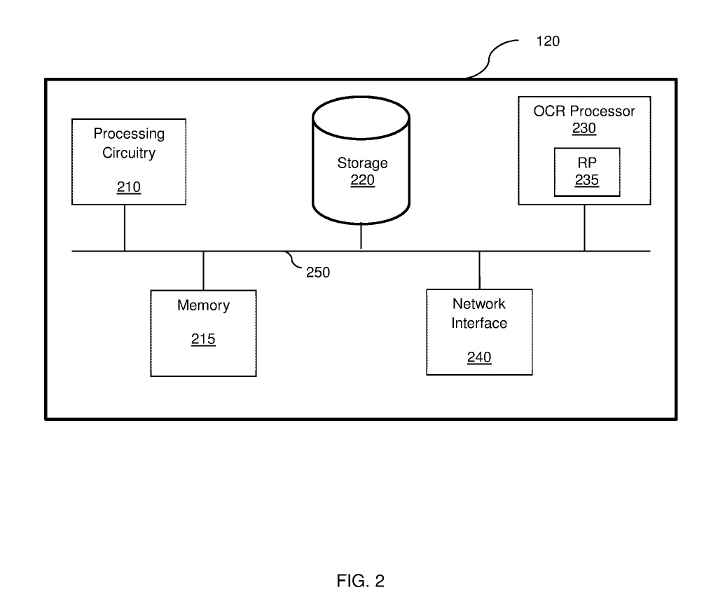

In an embodiment, the notification generator 120 is configured to create structured datasets based on received invalid electronic documents, including data at least partially lacking a known structure (e.g., unstructured data, semi-structured data, or structured data having an unrecognized structure). To this end, the notification generator 120 may be further configured to employ optical character recognition (OCR) or other image processing to determine data in the evidencing electronic document. The notification generator 120 may therefore include or be communicatively connected to a recognition processor (e.g., the recognition processor 235, FIG. 2).

In an embodiment, the notification generator 120 is configured to analyze the created structured datasets to identify transaction parameters related to transactions indicated in the documents, including an associated entity or entity device related to a transaction. In an embodiment, the notification generator 120 is configured to create templates based on the created structured datasets. Each template is a structured dataset including the identified transaction parameters for a transaction.

Using structured templates for determining an associated entity or entity device allows for more efficient and accurate determination than, for example, by utilizing unstructured data. Specifically, entities or entity devices may be quickly identified by comparing identification data, e.g., a user name or device media access control (MAC) address, to a known database, e.g., stored on the enterprise system 130. Further, data extracted from electronic documents and organized into templates requires less memory than, for example, images of scanned documents.

Based on the created template, the notification generator 120 is configured to identify an associated entity, and an entity device associated with the entity. A notification generator 120 is configured to generate a notification to be sent to the entity device to request additional information, such as a copy of an initial evidencing electronic document, or data from an initial evidencing electronic document. The notification may be configured to be displayed directly on the entity device.

For example, the notification generator 120 may analyze an invalid evidencing electronic document for the purchase of a hotel stay, e.g., a scanned receipt issued by the hotel, where a transaction date is missing or illegible, such as when it is determined that a “date” field of the template has a null value (i.e., the transaction date is missing). The notification generator 120 creates a notification asking an entity if a copy of the receipt is available, and if so, to submit a new scan of the receipt. If the entity responds that no copy of the receipt is available, the notification may then display a query to manually enter the date of the hotel stay to update the evidencing electronic document accordingly.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the notification generator 120 according to an embodiment. The notification generator 120 includes a processing circuitry 210 coupled to a memory 215, a storage 220, and a network interface 240. In an embodiment, the notification generator 120 may include an optical character recognition (OCR) processor 230. In another embodiment, the components of the notification generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, configure the processing circuitry 210 to perform the various processes described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a structured dataset including key fields and values.

The network interface 240 allows the notification generator 120 to communicate with the enterprise system 130, the database 140, the entity devices 150, or a combination thereof, for the purpose of, for example, retrieving invalid evidencing electronic documents, storing created templates, sending notifications, and the like.

It should be understood that the embodiments described herein are not limited to the specific architecture illustrated in FIG. 2, and other architectures may be equally used without departing from the scope of the disclosed embodiments.

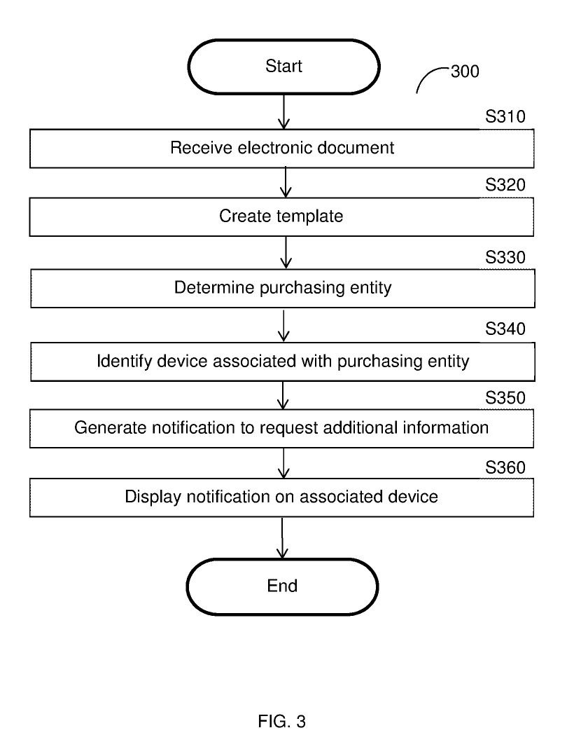

FIG. 3 is an example flowchart illustrating a method 300 for generating a notification related to an invalid evidencing electronic document according to an embodiment. In an embodiment, the method is performed by the notification generator 120 of FIG. 1.

At S310, an electronic document is received. The electronic document may include an invalid evidencing electronic document that is at least partially unstructured, and may include an indication of one or more missing transaction parameters.

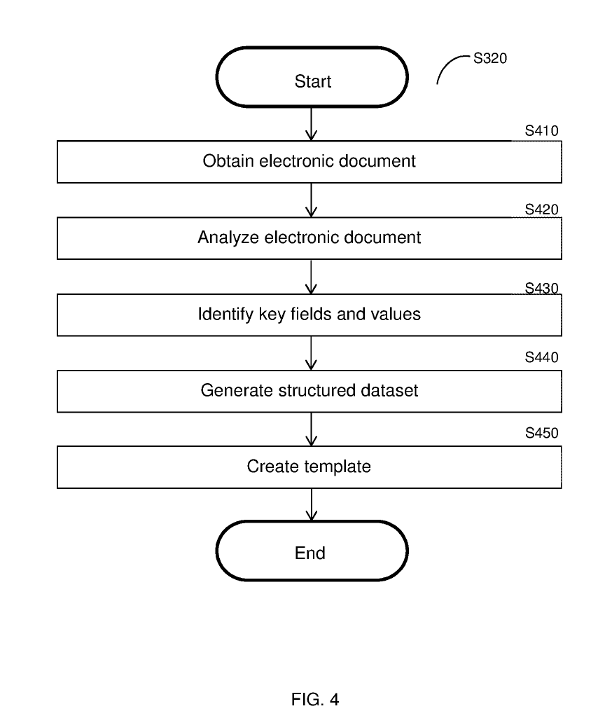

At S320, a template is created based on the received invalid evidencing electronic document. The template is a structured dataset including key fields and values identified in the evidencing electronic document. Creating templates for unstructured electronic documents is described further herein below with respect to FIG. 4 and in U.S. patent application Ser. No. 15/361,934, assigned to the common assignee, the contents of which are hereby incorporated by reference. In an embodiment, the structured dataset includes at least one transaction parameter associated with the electronic document.

At S330, based on the created template, a purchasing entity is determined. The purchasing entity may include, but is not limited to, an employee of an enterprise, a department within an enterprise, an enterprise representative, and the like. The purchasing entity may be determined based on the template, where the template includes data related to an entity associated with the evidencing document. For example, the template may include a field of “employee” that identified the employee who submitted the evidence. The “employee” field may include an employee name, an employee number, an associated employee email address, and the like. As another example, the purchasing entity may be indicated in a “buyer” field of the template that identifies a person that made a purchase.

At S340, a device associated with the purchasing entity is determined. The device may be a user device, such as a smartphone, a tablet, a personal computer, and the like, belonging to the purchasing entity. In an embodiment, the device includes the device that was used to submit the original invalid evidencing electronic document. The device may include an identifier, such as a MAC address or an internet protocol (IP) address.

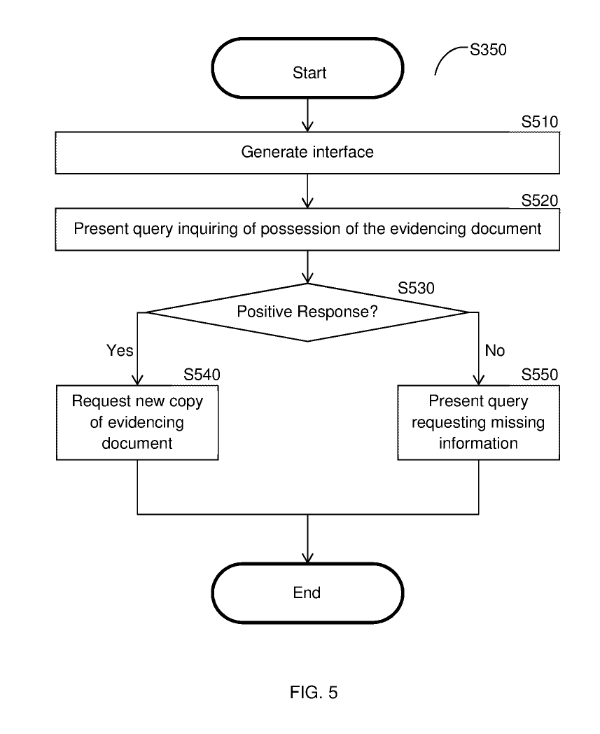

At S350, a notification is generated requesting additional information regarding the invalid evidencing electronic document. In an embodiment, the notification includes a two-step process, as further described in FIG. 5. As an example, the notification may include a query to be presented on the entity device asking if an original copy of the evidencing document used to create the invalid evidencing electronic document is available. The notification may further include a second query if a response to the first query is positive. The second query may request a new copy of the evidencing document be submitted. If a response to the first query indicates that no copy is available, a third query is presented, requesting the additional information be submitted in an alternative format, e.g., in text format.

At S360, the notification is displayed on the associated device. In an embodiment, the notification is displayed as described above, and the responses to at least one of the first, second, and third queries are received. The responses may be stored in a database, e.g., the database 140 of FIG. 1.

As a non-limiting example, a scanned receipt of a transaction in Germany to be utilized as evidence for a VAT reclaim is received, where the scanned receipt is previously determined to be invalid due to a date value that is illegible or missing, where it has been previously determined that a date value is a required parameter for a VAT reclaim submission. A template is created for the scanned receipt. The template is analyzed to determine that the employee John Smith was the entity who had originally submitted the receipt. The personal computer of John Smith is identified, e.g., over a company network. A notification is generated to be sent to the personal computer, where the notification requests submission of a new scanned copy of the receipt if available, and if not, submission of the date in text format if available. A response is received, and the invalid evidencing electronic document is updated accordingly.

FIG. 4 is an example flowchart relating to S320 of FIG. 3 illustrating a method for creating a structured dataset template based on an electronic document according to an embodiment.

At S410, the electronic document is obtained. Obtaining the electronic document may include, but is not limited to, receiving the invalid evidencing electronic document (e.g., receiving a scanned image of a receipt) at S310.

At S420, the electronic document is analyzed. The analysis may include, but is not limited to, using optical character recognition (OCR) to determine characters in the electronic document.

At S430, based on the analysis, key fields and values in the electronic document are identified. The key fields may include, but are not limited to, a merchant's name and address, a date of a transaction, currency used, a good or service sold, a transaction identifier, an invoice number, an employee associated with a transaction, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005,” the cleaning process will convert this data to 12/12/2005. As another example, if a name is presented as “Mo$den”, the cleaning process can change the name to “Mosden.” The cleaning process may be performed using external information resources, such as dictionaries, calendars, and the like.

At S440, a structured dataset is generated. The generated structured dataset (hereinafter structured dataset) includes the identified key fields and values.

At S450, based on the generated structured dataset, a template is created. The created template is a data structure including a plurality of fields and corresponding values. The corresponding values include transaction parameters identified in the structured dataset. The fields may be predefined.

In an embodiment, creating the template includes analyzing the generated structured dataset to identify transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the structured dataset may also include identifying the transaction based on the structured dataset.

Creating templates from electronic documents allows for faster processing due to the structured nature of the created templates. For example, query and manipulation operations may be performed more efficiently on structured datasets than on unstructured datasets lacking such structure. Further, organizing information from electronic documents into structured datasets, the amount of storage required for saving information contained in electronic documents may be significantly reduced. Electronic documents are often images that require more storage space than structured datasets containing the same information. For example, structured datasets representing data from 100,000 image electronic documents can be saved as data records in a text file. A size of such a text file would be significantly less than the size of the 100,000 images.

FIG. 5 is a flowchart describing a method relating to S350 of FIG. 3 for generating a notification interface according to one embodiment. At S510, an interface is generated. The interface may include a graphical interface configured to be displayed on an entity device. For example, the interface may include a window presenting a query and offering one or more response options to be displayed on an entity device display.

At S520, a first query is presented inquiring of possession of the evidencing document. For example, if the invalid evidencing electronic document is a scanned receipt of a hotel stay, where the original scanned receipt contains a date of transaction that is illegible, the first query may inquire if the entity has an available copy of the hotel receipt.

At S530, it is determined if a positive response is received regarding the first query. If so, execution continues with S540; otherwise, execution continues with S550.

At S540, a new copy of the evidencing document is requested via a second query. Following the above-mentioned example, a new scanned copy of the hotel receipt is requested. In an embodiment, the second query includes a link to a camera application or a similar image capturing portion or functionality on an entity device to record a new copy of the evidencing document. After the request is sent, the execution ends.

At S550, a third query is presented requesting missing information related to the invalid evidencing electronic document. Continuing the aforementioned example, a date of the hotel stay is requested from the entity. For example, a calendar may be displayed to allow a selection of a date corresponding to the hotel stay. In an embodiment, multiple options are presented as available possible responses to the third query. As a non-limiting example, if it is determined that the hotel stay could have occurred on three possible dates, each of the dates are presented as a possible response. This allows for a quick and easy response to the third query. After the request is sent, the execution ends.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a notification related to an electronic document including at least partially unstructured data, comprising:
analyzing the electronic document to determine at least one transaction parameter, the at least one transaction parameter indicating at least one entity;
creating a template for the electronic document, wherein the template is a structured dataset including the at least one transaction parameter;
determining, based on the template, an entity device associated with one of the at least one entity; and
sending, to the entity device, a notification requesting additional information for the electronic document.

2. The method of claim 1, wherein determining the at least one entity further comprises:
identifying, in the electronic document, at least one key field and at least one value;
creating, based on the electronic document, a structured dataset, wherein the created structured dataset includes the at least one key field and the at least one value; and
analyzing the created structured dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the invalid evidencing electronic document further comprises:
performing optical character recognition on the electronic document.

5. The method of claim 1, wherein sending the notification further comprises:
generating an interface including at least one query for information related to the electronic document.

6. The method of claim 5, wherein the at least one query is for at least one of: an original document represented by the electronic document; a new copy of the electronic document; and missing information of the electronic document.

7. The method of claim 6, wherein the missing information includes at least one required transaction parameter that is not included in the template.

8. The method of claim 6, wherein the at least one query includes a request to access an image capturing portion of the entity device.

9. The method of claim 5, wherein the interface further includes at least one possible response option to the at least one query.

10. A non-transitory computer readable medium having stored thereon instructions for causing a processing circuitry to perform a process for generating a modified evidencing electronic document including missing elements based on an electronic document including at least partially unstructured data, the process comprising:
analyzing the electronic document to determine at least one transaction parameter, the at least one transaction parameter indicating at least one entity;
creating a template for the electronic document, wherein the template is a structured dataset including the at least one transaction parameter;
determining, based on the template, an entity device associated with one of the at least one entity; and
sending, to the entity device, a notification requesting additional information for the electronic document.

11. A system for generating a notification related to an electronic document including at least partially unstructured data, comprising:
a processing circuitry; and
a memory, the memory containing instructions that, when executed by the processing circuitry, configure the system to:
analyze the electronic document to determine at least one transaction parameter, the at least one transaction parameter indicating at least one entity;
create a template for the electronic document, wherein the template is a structured dataset including the at least one transaction parameter;
determine, based on the template, an entity device associated with one of the at least one entity; and
send, to the entity device, a notification requesting additional information for the electronic document.

12. The system of claim 11, wherein determining the at least one entity further comprises:
identifying, in the electronic document, at least one key field and at least one value;
creating, based on the electronic document, a structured dataset, wherein the created structured dataset includes the at least one key field and the at least one value; and
analyzing the created structured dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the electronic document.

15. The system of claim 11, wherein the system is further configured to:
generate an interface including at least one query for information related to the electronic document.

16. The system of claim 15, wherein the at least one query is for at least one of: an original document represented by the electronic document; a new copy of the electronic document; and missing information of the electronic document.

17. The system of claim 16, wherein the missing information includes at least one required transaction parameter that is not included in the template.

18. The system of claim 16, wherein the at least one query includes a request to access an image capturing portion of the entity device.

19. The system of claim 15, wherein the interface further includes at least one possible response option to the at least one query.
